(19) United States
(12) Patent Application Publication
(10) Pub. No.: US 2015/0224658 A1
(43) Pub. Date: Aug. 13, 2015

(54) Julienning/Dicing Food Pusher Having Easy-Clean Configuration

(71) Applicant: Edlund Company, LLC, Burlington, VT (US)

(72) Inventor: Ryan S. Whitney, Essex Junction, VT (US)

(21) Appl. No.: 14/618,425

(22) Filed: Feb. 10, 2015

Related U.S. Application Data
(60) Provisional application No. 61/937,903, filed on Feb. 10, 2014.

(51) Int. Cl. B26D 1/00; B26D 3/26; B26D 1/03

(52) U.S. Cl. CPC B26D 1/0006; B26D 1/03; B26D 3/26; B26D 2001/0066

(57) ABSTRACT

Julienning/dicing food pushers having backings that include strategically located wash openings that promote efficient cleaning of the pushers. Each food product pusher is designed and configured for use with a thrust-type food product cutting apparatus and includes crisscrossing blade-receiving channels that receive blades of a blade grid during a cutting operation. The crisscrossing channels form intersections and define food pusher fingers that extend into food openings within the corresponding blade grid. The pusher fingers are supported by a backing that includes wash openings that expose, from the backside of the food product pusher, the channel intersections and portions of the channels beyond the intersections. These wash openings are particularly effective in cleaning the channels of compacted remnants of food products cut during cutting operations.

### RELATED APPLICATION DATA

This application claims the benefit of priority of U.S. Provisional Patent Application Ser. No. 61/937,903, filed on Feb. 10, 2014, and titled “FEATURES FOR ENHANCING SAFETY AND OPERABILITY OF THRUST-TYPE FOOD PRODUCT-CUTTING APPARATUSES, AND APPARATUSES INCORPORATING SUCH FEATURES,” which is incorporated by reference herein in its entirety.

This application is related to the following nonprovisional applications filed herewith:
U.S. patent application Ser. No. ______, filed on Feb. 10, 2015, and titled “FOOD PRODUCT CUTTING APPARATUS HAVING ONBOARD PUSHER AND BLADE CARTRIDGE STORAGE, AND PUSHER/BLADE CARTRIDGE SETS SUITABLE THEREFOR;”
U.S. patent application Ser. No. ______, filed on Feb. 10, 2015, and titled “FOOD PRODUCT CUTTING APPARATUS HAVING ANTI-BINDING FOOD PUSHER GUIDE MECHANISM;”
U.S. patent application Ser. No. ______, filed on Feb. 10, 2015, and titled “HAND OPERATED FOOD CUTTING APPARATUS HAVING A SELF-STABILIZING PUSHER-ARM MECHANISM, AND A FOOD STABILIZING PUSHER-ARM MECHANISM FOR A FOOD CUTTING APPARATUS;” and
U.S. patent application Ser. No. ______, filed on Feb. 10, 2015, and titled “FOOD PRODUCT CUTTING APPARATUS HAVING USER-SELECTABLE HORIZONTAL AND VERTICAL MOUNTS THAT PROVIDE THE SAME THRUST AXIS ORIENTATION.”
   Each of the foregoing related applications is incorporated herein by reference in its entirety.

### FIELD OF THE INVENTION

The present invention generally relates to the field of food product cutting apparatuses. In particular, the present invention is directed to a Julienning/dicing food pusher having an easy-clean configuration.

### BACKGROUND

Preparing food dishes often involves cutting various food products into pieces of desired forms and sizes. Examples of such cutting includes slicing, dicing, Julienning, and wedging. On a small scale, these cutting operations are typically performed using knives. However, on a larger scale, various machines are used to assist with these cutting operations. Such machines range from mandolin slicers, to rotary-type food processors, to manual and powered slicing and other cutting machines. One type of cutting machine used in commercial kitchens for cutting hard food products, such as onions, bell peppers, potatoes, etc., is a thrust-type machine, which can be manually or automatedly actuated. In a typical thrust-type cutting machine, the food product is thrust into a set of blades that cleave the food product into multiple pieces. Depending on the configuration of the blade set, such thrust-type cutting machines can be used for slicing (parallel blades only), wedging (radial blades), Julienning (gridded blades), and dicing (gridded blades (following a pre-slicing operation)).

### SUMMARY

In an implementation, the present disclosure is directed to a food product pusher for a food product cutting apparatus having a pusher holder and a blade set having a Julienning/dicing blade grid defining a plurality of food openings through which the food product pusher pushes food during a cutting operation of the food product cutting apparatus. The food product pusher includes a plurality of pusher fingers defined by first set of channels having first longitudinal axes extending in a first direction and a second set of channels having a second longitudinal axes extending in a second direction different from the first direction so that the first set of channels cross the second set of channels so as to define the pusher fingers and to form a plurality of intersections, the first and second sets of channels being located so that, when the food product pusher is engaged with the pusher hold, the pusher hold can push the food product pusher so that the pusher fingers extend, correspondingly and respectively, into the food openings of the Julienning/dicing blade grid; and a backing supporting the pusher fingers in fixed relation to one another and having a back side opposite the pusher fingers, the backing including a plurality of wash openings extending from the back side to the first and second sets of channels, wherein each of the wash openings fluidly communicates with at least one of the intersections.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a front-elevational view of a manually operated food product cutting apparatus of the present invention mounted on a movable chassis;

FIG. 2 is a rear-elevational view of the food product cutting apparatus of FIG. 1;

FIG. 3 is a side-elevational view of the food product cutting apparatus of FIG. 1, showing the pusher arm in a resting-open position;

FIG. 4 is a side-elevational view of the food product cutting apparatus of FIG. 1, showing the pusher arm in an intermediate position and showing the side support and a portion of the food product rest removed for clarity;

FIG. 5 is a side-elevational view of the food product cutting apparatus of FIG. 1, showing the pusher arm in a fully-closed position with the pusher engaged with the blade set and showing the side support removed;

FIG. 6 is a side-elevational view of the food product cutting apparatus of FIG. 1, showing the pusher arm in a fully-closed position with the pusher engaged with the blade set;

FIG. 7 is a side-elevational view of the food product cutting apparatus of FIG. 1, secured to a horizontal-mounting support;

FIG. 8 is a rear-elevational view of the assembly of FIG. 7;

FIG. 9 is an isometric view of the food product cutting apparatus of FIG. 1, secured to a vertical-mounting support;

FIG. 10 is a side-elevational view of the assembly of FIG. 9;

FIG. 11 is an isometric view of the Julienning/dicing blade cartridge of the food product cutting apparatus of FIG. 1, showing the blade cartridge partially disassembled;

FIG. 12 is an isometric view of a blade-cartridge/pusher set, showing a wedging pusher in spaced relation with a corresponding wedging blade cartridge that can be used in a food product cutting apparatus, such as the food product cutting apparatus of FIG. 1;

FIG. 13 is an isometric view of the blade-cartridge/pusher set of FIG. 12, showing the pusher fully engaged with the blade cartridge;

FIG. 14 is an isometric view of the blade-cartridge pusher set combination of FIG. 13 engaged by a retainer/wash cover;

FIG. 15 is a perspective partial view of the food product cutting apparatus of FIG. 1, showing a blade-cartridge/pusher set stowed in the chassis of the food product cutting apparatus of FIG. 1 along with its retainer/wash cover;

FIG. 16 is a perspective view of the blade-cartridge/pusher set of FIG. 15 engaged by its retainer/wash cover;

FIG. 17 is a perspective view of the blade-cartridge/pusher set of FIG. 15 along with its retainer/wash cover, showing the retainer/wash cover removed from the blade-cartridge/pusher set;

FIG. 18 is a perspective view of the blade cartridge of FIG. 15;

FIG. 19 is a perspective partial view of the food product pusher apparatus of FIG. 1, showing the quick-connect pusher receiver of the food product cutting apparatus, showing the receiver in its resting-open position and engaged by a wedging pusher;

FIG. 20 is a perspective view of the upper end of the food product cutting apparatus of FIG. 1, showing the sliding engagement of the pusher assembly with the pair of support slides;

FIG. 21 is perspective partial view of the food product-pusher apparatus of FIG. 1, showing the tool-less blade-cartridge lock in an open position;

FIG. 22 is a side-elevational partial view of an alternative cutting apparatus of the present invention that includes a retractable food product stabilizer, showing a portion of the product guide removed for clarity;

FIG. 23 is a side-elevational partial view of the cutting apparatus of FIG. 22, showing a food product engaged with the retractable food product stabilizer and the pusher arm in a resting-open position and also showing the product guide removed for clarity;

FIG. 24 is a side-elevational partial view of the cutting apparatus and food product of FIG. 23, showing the pusher arm in an intermediate position with the pusher initially engaging the food product and also showing the product guide removed for clarity;

FIG. 25 is a side-elevational partial view of the cutting apparatus of FIGS. 22-24 showing the pusher arm in a fully closed position and also showing the product guide removed for clarity;

FIG. 26 is an isometric view of the movable horizontal mount of FIGS. 1-6 and 22-25;

FIG. 27 is an isometric view of the universal fixed mount shown in a horizontal orientation for use in fixed horizontal mount application, such as illustrated in FIGS. 7 and 8;

FIG. 28 is an isometric view of the universal fixed mount shown in a vertical orientation for use in fixed vertical mount application, such as illustrated in FIGS. 9 and 10;

FIG. 29 is a bottom view of an exemplary easy-clean Julienning/dicing food pusher;

FIG. 30 is a top view of the food product pusher of FIG. 29;

FIG. 31 is a side view of the food product pusher of FIG. 29;

FIG. 32 is an enlarged partial cross-sectional view as taken along line 32-32 of FIG. 29;

FIG. 33 is a bottom view of another exemplary easy-clean Julienning/dicing food product pusher;

FIG. 34 is a top view of the food product pusher of FIG. 33;

FIG. 35 is a side view of the food product pusher of FIG. 33; and

FIG. 36 is an enlarged partial top view of the food product pusher of FIG. 33.

### DETAILED DESCRIPTION

As will be understood from reading this entire disclosure, aspects of the present invention are directed to, among other things, Julienning/dicing food product pushers having easy-clean features. Conventional Julienning/dicing food product pushers are difficult to clean because remnants of food products being cut using the pushers become compacted within the blade-receiving channels that define the pusher fingers, which extend into the food openings of a Julienning/dicing blade grid to push the cut food products therethrough near the end of a cutting operation. Cleaning the compacted food remnants from these channels typically requires the use of an implement, tool, knife, brush, etc., to help remove the food remnants by mechanical cleaning action. Once someone has performed a mechanical cleaning of a conventional Julienning/dicing food product pusher, the food product pusher can be washed and sanitized. The mechanical cleaning portion of the cleaning and sanitization process is time and labor intensive. However, the present inventor has discovered that by providing Julienning/dicing food product pushers with strategically designed wash openings, the amount of mechanical cleaning needed can be dramatically reduced and often eliminated.

At a high level, an easy-clean Julienning/dicing food product pusher of the present disclosure includes pusher fingers defined by sets of crisscrossing blade-receiving channels that receive corresponding crisscrossing blades of a Julienning/dicing blade grid during a cutting operation. Such a food product pusher also includes a backing that supports the pusher fingers and includes wash openings that the present inventor has discovered are particularly effective for cleaning food remnants from the crisscrossing channels when the wash openings expose not only the roots of the intersections of the crisscrossing channels but also portions of the channels adjacent to the intersections. When wash water or wash solution is forced through such wash openings, the force of that water or solution forces the compacted food remnants out of the intersections and channels. Julienning/dicing food product pushers made in accordance with the present invention can be used with any suitable food product cutting apparatuses, such as the thrust-type food product cutting apparatuses described below and incorporated by reference below. Before proceeding with describing some exemplary embodiments of easy-clean food product pushers, it is noted that the term “Julienning/dicing,” when used to modify “food product pusher,” “blade grid,” and related terms, is used herein and in the appended claims to denote that the pusher can be used for both Julienning and dicing. As those skilled in the art will readily understand, the difference between Julienning and dicing is that in dicing, there is an additional cutting step wherein the food product is cut in a different direction from the dicing cut.

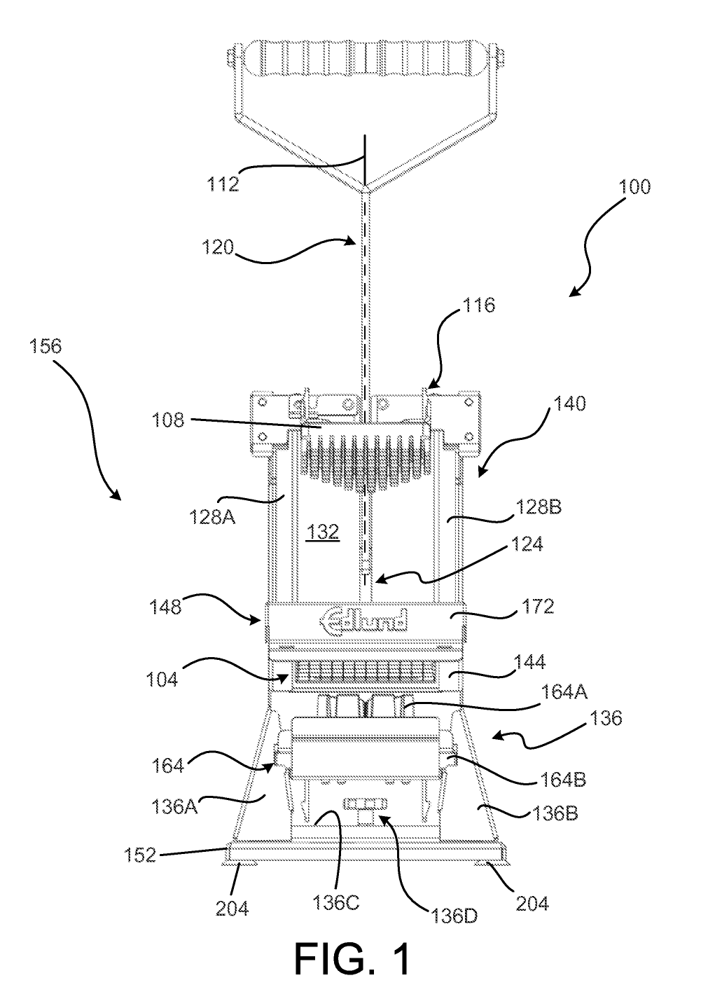

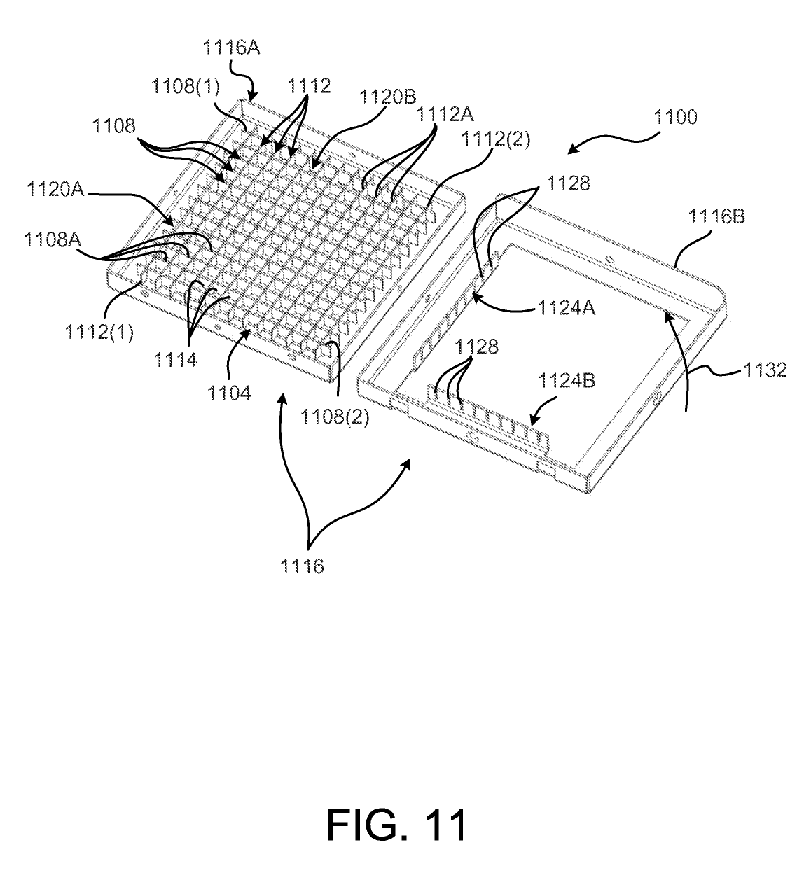

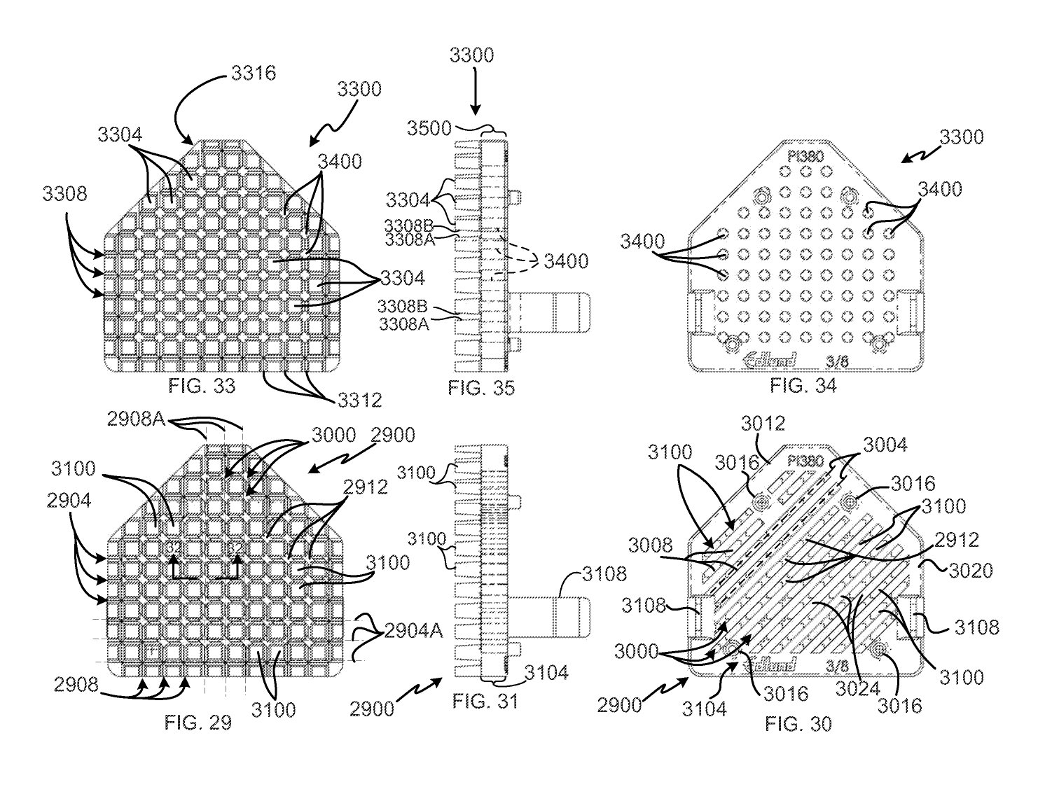

Turning now to the drawings, FIGS. 29-32 illustrate an exemplary easy-clean Julienning/dicing food product pusher 2900 particularly configured for use with food product cutting apparatus 100 of FIG. 1 and a corresponding Julienning/dicing blade grid, such as found in blade cartridge construction 1100 illustrated in FIG. 11. That said, those skilled in the art will understand that the particular configuration illustrated can be changed to suit different food product cutting apparatuses, such as apparatuses not having food product guide 132 (e.g., FIG. 1), having a differently shaped food product guide, having a different blade grid configuration (e.g., non-square, non-rectangular, etc.), or suitable combination of these, among others. Referring first to FIG. 31, Julienning/dicing food product pusher 2900 includes a plurality of pusher fingers 3100 (only some labeled in each figure to avoid clutter; non-perimeter fingers are essentially identical to one another) secured to a backing 3104 that firmly supports the pusher fingers. In some embodiments, pusher fingers 3100 and backing 3104 are formed monolithically with one another, such as by molding and/or machining In other embodiments, pusher fingers 3100 can be formed separately and secured to backing 3104 in any suitable manner, such as by mechanical fastening, adhesive bonding, brazing, welding, etc. Each of pusher fingers 3100 and backing 3104 may be made of any suitable material, such as plastic, metal, ceramic, wood, etc.

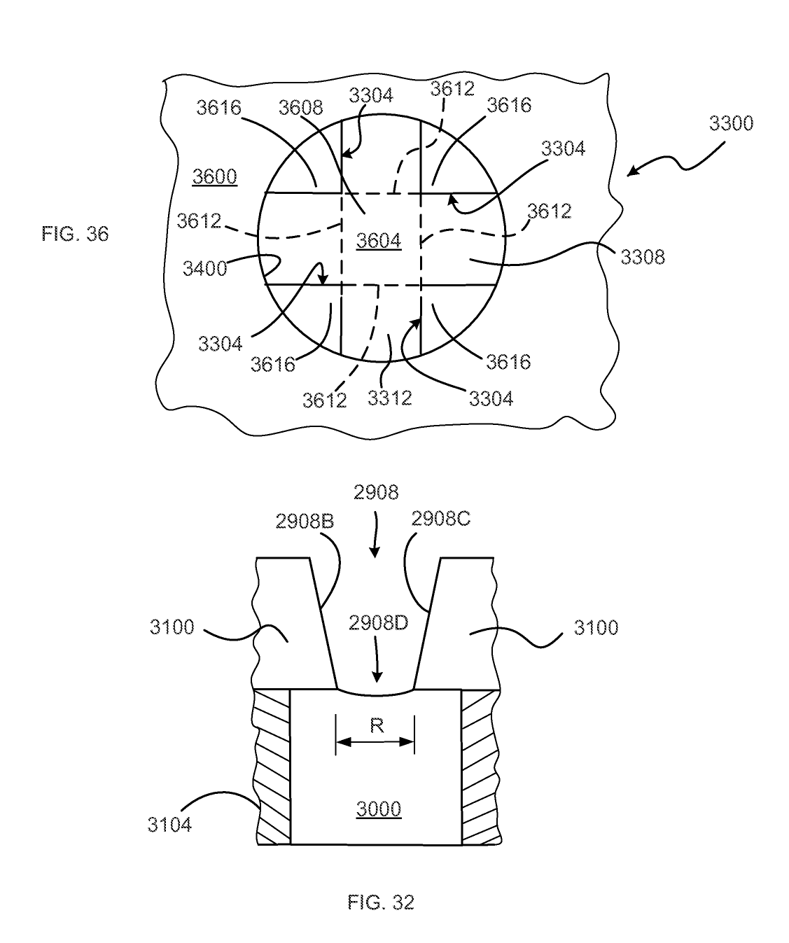

Referring now to FIG. 29, pusher fingers 3100 are defined by crisscrossing channels 2904 (one direction) and 2908 (other direction) that receive corresponding crisscrossing blades of a Julienning/dicing blade grid (not shown) during use near the end of a cutting operation. It is noted that only some of channels 2904 and 2908 are labeled to avoid clutter. Each channel 2904 and 2908 has a corresponding longitudinal axis 2904A and 2908A, and each pair of crossing channels forms a corresponding intersection 2912 (only some labeled for convenience to avoid clutter). As seen best in FIG. 32, in this embodiment each channel 2908 has sidewalls 2908B and 2908C that taper to a minimum spacing, R, at the root 2908D of the channel. While FIG. 32 illustrates only the configuration of each channel 2908, it is noted that each channel 2904 in this embodiment has the same tapered configuration and minimum wall spacing R at its root. The channel wall configuration can be different in other embodiments if desired. For example, the channel walls may not have any taper or may be tapered differently and/or stepped, among other things.

As seen in FIG. 30, backing 3104 has a plurality of wash openings, which in this case are elongated wash opening slots 3000 (only a few labeled to avoid clutter) that extend parallel to fictitious lines, such as line 3004, that run along the diagonals of the square-shaped bases, such as bases 3008, portions of which are exposed by the wash opening slots. In the embodiment shown, each wash opening slot 3000 extends a substantial portion of the distance from the perimeter 3012 of backing 3104 proximate one end of that slot to the opposite end of that slot, essentially except where pusher alignment structures 3016 are present. As can be seen in both FIGS. 29 and 30, this alignment of wash opening slots 3000 exposes the roots of channels 2904 and 2908 not only at intersections 2912 of these channels but portions of the channels adjacent to the intersections. Viewing the construction of backing 3104 differently, the backing can be considered to have a perimeter frame 3020 and a plurality of spaced apart elongated finger supports 3024 (only a few labeled to avoid clutter) that each join with the perimeter frame at both ends of that finger support. The spacing of such finger supports 3024, then, defines wash opening slots 3000. The configuration of wash opening slots 3000 illustrated generally has each pusher finger 3100 supported by two finger supports 3024. In addition to pusher alignment structures 3016 that aid in aligning food product pusher 2900 with a corresponding pusher head (not shown, but which is a structure that receives the food product pusher) and inhibit the food product pusher from moving excessively laterally relative to the pusher head, another (optional) feature of the illustrated food product pusher is a pair of interference-fit spring-type locking members 3108 for removably securing the food product pusher to the corresponding pusher head.

FIGS. 33-36 illustrate another easy-clean Julienning/dicing food product pusher 3300 having wash openings 3400 (FIG. 34) (only a few labeled to avoid clutter) configured in a manner consistent with the general principles described above. In this example, food product pusher 3300 is largely identical to food product pusher 2900 of FIGS. 29-32 except for the configuration of wash openings 3400. For example, pusher fingers 3304 of food product pusher 3300 are arranged in a rectangular (here, square) grid pattern formed by crisscrossing channels 3308 and 3312 (only a few of each are labeled to avoid clutter), each non-perimeter pusher finger is square in shape as viewed in FIG. 33, the crisscrossing channels have tapered walls, see FIG. 35 wherein walls 3308A and 3308B can be seen, the perimeter 3316 of the food product pusher is shaped to conformally engage food product guide 132 of food product cutting apparatus 100 of FIG. 1, and the food product pusher may be considered to have a backing 3500 (FIG. 35) that fixedly supports the pusher fingers. Other optional features not labeled in the figures but resembling features described above relative to FIGS. 29-32 may be considered to be the same as those described features.

As best seen in FIG. 36, in this example each wash opening 3400 has a circular shape when viewed from the backside 3600 of food product pusher 3300, and the transverse cross-sectional area of each wash opening is greater than the root area 3604 of the corresponding intersection 3608 of the underlying channels 3308 and 3312. Root area 3604 of intersection 3608 is taken as the area of the intersection at the bases of the four adjacent pusher fingers 3304 and laterally defined by lines 3612 that each represent the location where the corresponding wall of the respective channel 3308 and 3312 would be if there were no intersection. When each wash opening 3400 is concentrically aligned with corresponding root area 3604 when viewed from backside 3600, the larger area of wash opening 3400 relative to root area 3604 of intersection 3608 exposes corners 3616 of the four adjacent pusher fingers 3304, thereby also exposing portions of channels 3308 and 3312 beyond intersection 3608. When one wash opening 3400 is provided for a corresponding intersection 3608, the cross-sectional shape of the wash opening may be other than circular, such as rectangular, oval, etc., as long as the cross-sectional area is larger than root area 3604 of the intersection.

Those skilled in the art will understand that the two illustrated configurations of wash openings illustrated, respectively in FIGS. 29-32 and 33-36 are merely illustrative and that many other configurations are possible using the basic principles noted above. For example, a configuration that is a hybrid of the configuration of FIGS. 29-32 and the configuration of FIGS. 33-36 may include wash openings that are slots, but wherein each slot exposes only two channel intersections so as to leave a sufficient amount of backing material to provide the needed structural support for the pusher fingers. Those skilled in the art will be able to derive other configurations that are suited to the particular configuration and arrangement of pusher fingers for any particular Julienning/dicing food product pusher.

In addition to the foregoing aspects, other aspects of the present disclosure are directed to various features and functionalities for food product-cutting apparatuses, such as mechanical thrust-type apparatuses that may be configured for slicing, Julienning, wedging, dicing, and any combination thereof. Still other aspects of the present disclosure are directed to food product-cutting apparatuses that include one or more of these features and functionalities. Examples of the features and functionalities disclosed herein include, but are not necessarily limited to:
a food product-cutting apparatus that can be mounted on differing types of mounts, such as a fixed horizontal mount, a fixed vertical mount, and a movable horizontal mount;
a retractable food product stabilizer that stabilizes the food product in the food product-cutting apparatus prior to the cutting operation;
a cantilevered blade-set design that allows easy access for collection pans to be moved into and out of position beneath the blade set;
a backward-leaning design that assists with product stability;
a chassis configured for storing a blade-cartridge/pusher set;
a tool-less and fastener-less retainer for securely holding a pusher and corresponding blade cartridge safely together for stowing;
a snap-fit retainer/wash cover for securely holding a pusher and corresponding blade cartridge safely together for washing;
a tool-less and fastener-less blade-cartridge lock for securely holding the blade-cartridge in its operational location;
a quick-connect pusher design that allows the pusher to be readily installed and removed from the food product-cutting apparatus;
an anti-binding guide mechanism for guiding a pusher assembly along its cutting thrust axis;
a Julienning/dicing blade cartridge having a simplified blade-tensioning arrangement; and
a pusher-arm mechanism that enables a compact design and provides the pusher arm with a stable resting-open position.

For convenience, each of the listed features and functionalities is described below in conjunction with a particular food product-cutting apparatus. Although this apparatus is used to illustrate many of these features and functionalities and although apparatus is shown as including many of these features and functionalities, those skilled in the art will readily appreciate that many of these features and functionalities can be implemented in other food product-cutting apparatus, such as the apparatus described in U.S. patent application Ser. No. 14/163,858 filed on Jan. 24, 2014, and titled “FOOD PRODUCT SLICERS HAVING A DOUBLE-BEVELED BLADE ARRANGEMENT, AND FEATURES USABLE THEREWITH,” U.S. patent application Ser. No. 14/163,897 filed on Jan. 24, 2014, and titled “MULTILEVEL BLADE CARTRIDGES FOR FOOD PRODUCT SLICERS AND FOOD PRODUCT SLICERS INCORPORATING MULTILEVEL BLADE CARTRIDGES,” U.S. patent application Ser. No. 14/163,918, filed on Jan. 24, 2014, and titled “FOOD PRODUCT SLICERS HAVING FOOD PRODUCT CRADLES,” U.S. patent application Ser. No. 14/163,934, filed on Jan. 24, 2014, and titled “FOOD PRODUCT SLICERS HAVING CAMMED SLICING-CLEAVING ACTIONS,” and U.S. patent application Ser. No. 14/163,947, filed on Jan. 24, 2014, and titled “PRODUCT PUSHERS FOR FOOD PRODUCT SLICERS AND FOOD PRODUCT SLICERS INCLUDING SUCH PRODUCT PUSHERS,” each of which is incorporated herein by reference for its teachings of differing types of food product-cutting apparatuses. Those skilled in the art will readily understand how to implement each of the foregoing features in relevant ones of the food product-cutting apparatuses. Further, those skilled in the art will readily understand while the food product-cutting apparatus illustrated herein contains multiple ones of the foregoing features, other food product-cutting apparatuses made in accordance with the present invention may have any one or more of the disclosed features and functionalities and in any logical combination relative to the food product-cutting apparatus at issue.

Before describing each of the forgoing features and functionalities in detail, the exemplary thrust-type food product-cutting apparatus, hereinafter, simply “cutting apparatus 100” or “the cutting apparatus,” used to illustrate many of these features and functionalities is first described generally to assist the reader with understanding the specific features and functionalities.

Referring now to FIGS. 1-3, cutting apparatus 100 includes a blade set 104 and a food product-pusher 108 movable along a cutting thrust axis 112 to push a food product (not shown, but such as a potato, onion, bell pepper, etc.) through the blade set to cut, for example, cleave, the food product into multiple pieces. As noted in the Background section, above, the nature of the pieces depends upon a number of factors, such as the configuration of blade set (e.g., grid pattern for Julienned pieces or diced pieces, or radial pattern for wedged pieces) and whether or not the food product was cut in a prior operation. Regarding the latter, if the food product was previously cut into slices, then a thrusting of the slices through a gridded blade set will result in diced pieces.

In the embodiment shown, product pusher 108 is moved along cutting thrust axis 112 via a pusher assembly 116 that is moved using a manually operated pusher arm 120 coupled to a linkage mechanism 124. Pusher assembly 116 is slidable along a pair of slide rails 128A and 128B, which in this example are non-cylindrical members that inhibit binding often found in conventional thrust-type cutting apparatuses having cylindrical rods for guides. In the present embodiment, slide rails 128A and 128B are monolithically integrated with lateral sides of a generally V-shaped product guide 132 that, as described below in detail, assists in holding a food product in proper position and orientation during cutting operations. Pusher arm 120 includes a handle 120A that is easily graspable by a user and is located and oriented for easy operation of cutting apparatus 100.

Cutting apparatus 100 comprises a chassis 136 having an upper body 140, which provides support for the upper ends of slide rails 128A and 128B, and, in this example, the upper end of product guide 132. Blade set 104 in the embodiment shown is in the form of a blade cartridge 144, and, correspondingly, cutting apparatus 100 includes a blade-cartridge receiver 148, which is supported by chassis 136 in a manner that it is both cantilevered and angled upward. Benefits of this arrangement are described below in detail.

With the general arrangement of exemplary cutting apparatus 100 in mind, following are detailed descriptions of specific features and functionalities, including the features and functionalities listed above.

### 1) Mounting Flexibility

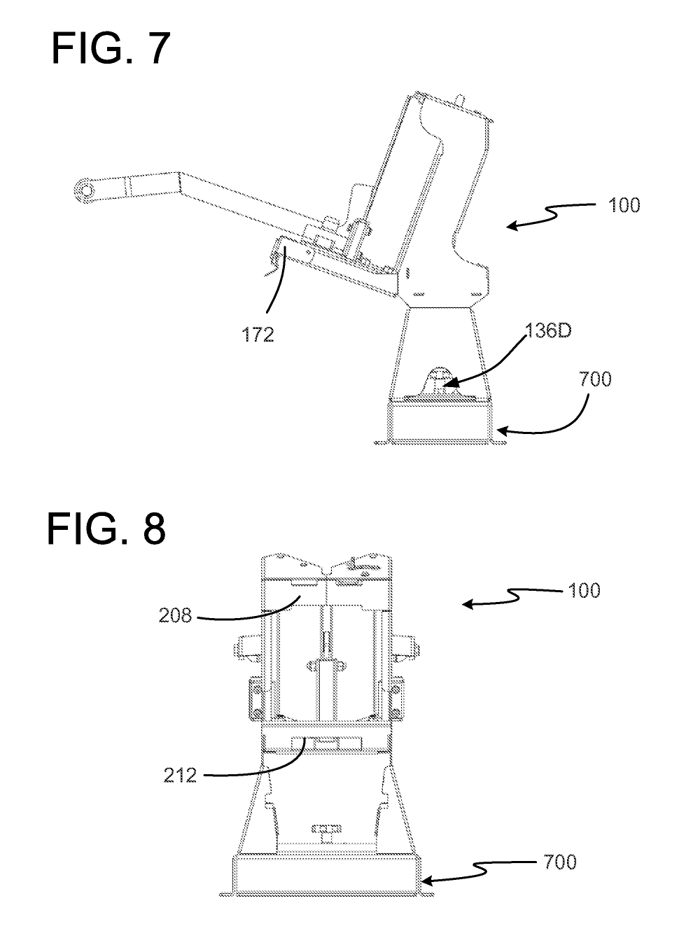

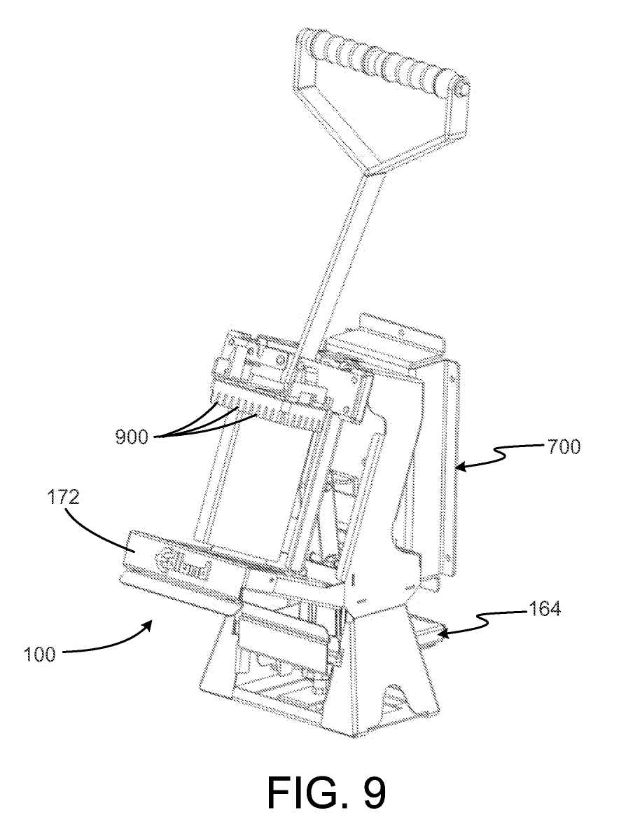

Cutting apparatus 100 is specially designed for being mounted in differing manners, here, to a movable horizontal mount 152 (see, e.g., FIGS. 1-6 and 26) and to a universal fixed mount 700 (FIGS. 7-10, 27, and 28), which is shown in a horizontal orientation in FIGS. 7, 8, and 27 and in a vertical orientation in FIGS. 9, 10, and 28. These differing mounting options provide a number of benefits, such as having to make a single apparatus that users can customize simply by selecting the desired mount and/or mount orientation and allowing a user to use a single cutting apparatus in multiple locations. Regarding the former, a manufacture may, for example, sell cutting apparatus 100 separately from differing mounts 152, 700 such that a customer would buy only the mount(s) desired. Regarding the latter, a user may, for example, from time to time want to move cutting apparatus 100 from a countertop location (e.g., using either of movable horizontal mount 152 or universal fixed mount 700 in a horizontal orientation) to a vertical mount location, such as to cut a large number of potato fries and have them drop into a large container that sits on the floor. If the scenario is moving cutting apparatus from a fixed horizontal mount to a fixed vertical mount, the user can have two universal mounts 700, one permanently mounted in a horizontal orientation and the other permanently mounted in a vertical orientation.

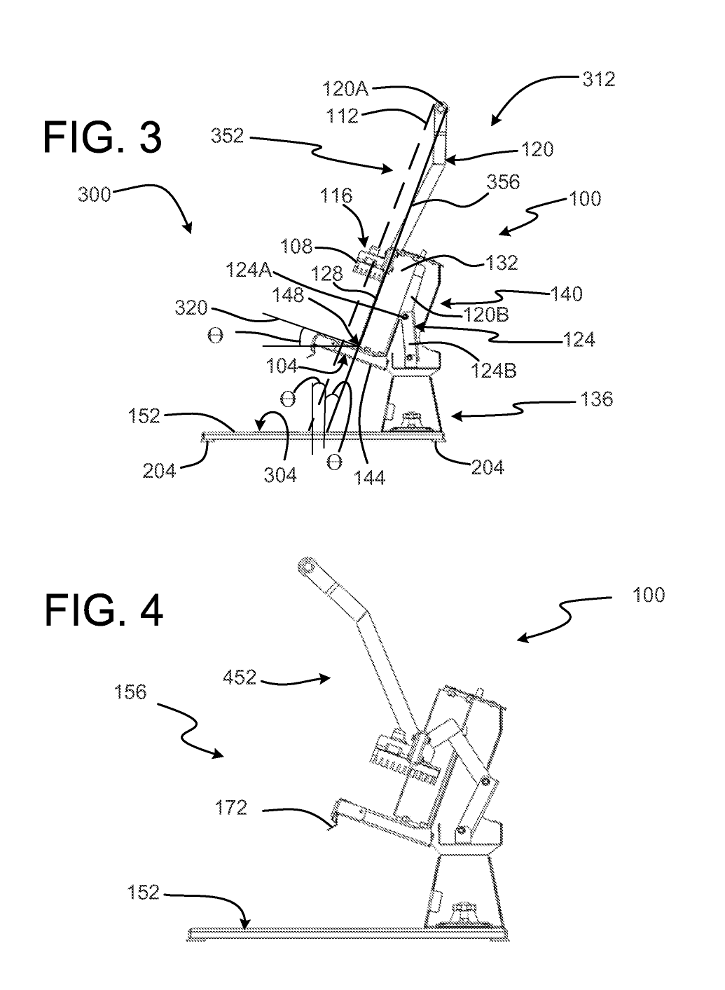

Referring first to FIGS. 1-6 and 26, when cutting apparatus 100 is secured to movable horizontal mount 152, a user can move the combined unit 156 freely without undoing any mechanical engagement, allowing the user to move the combined unit, for example, to another location for use, storage, or cleaning there or to facilitate cleaning around and under the location from which it is moved. In the example shown, movable horizontal mount 152 extends beyond the front 300 (FIG. 3) of cutting apparatus 100 to provide stability for the cutting apparatus as a user performs a cutting operation by exerting forward and/or downward force on handle 120A. Also in the example shown, movable horizontal mount 152 provides an expansive flat surface 304 for receiving a container (not shown) that catches pieces of the food product (not shown) after being cut by blade set 104. However, in other embodiments, movable horizontal mount 152 may be configured differently so as to not include expansive flat surface 304. For example, such an alternative movable horizontal mount may be U-shaped with chassis 136 of cutting apparatus 100 being secured to the mount at the base of the U-shape, with the legs of the U-shape extending beyond front 300 of the cutting apparatus. Other configurations are possible.

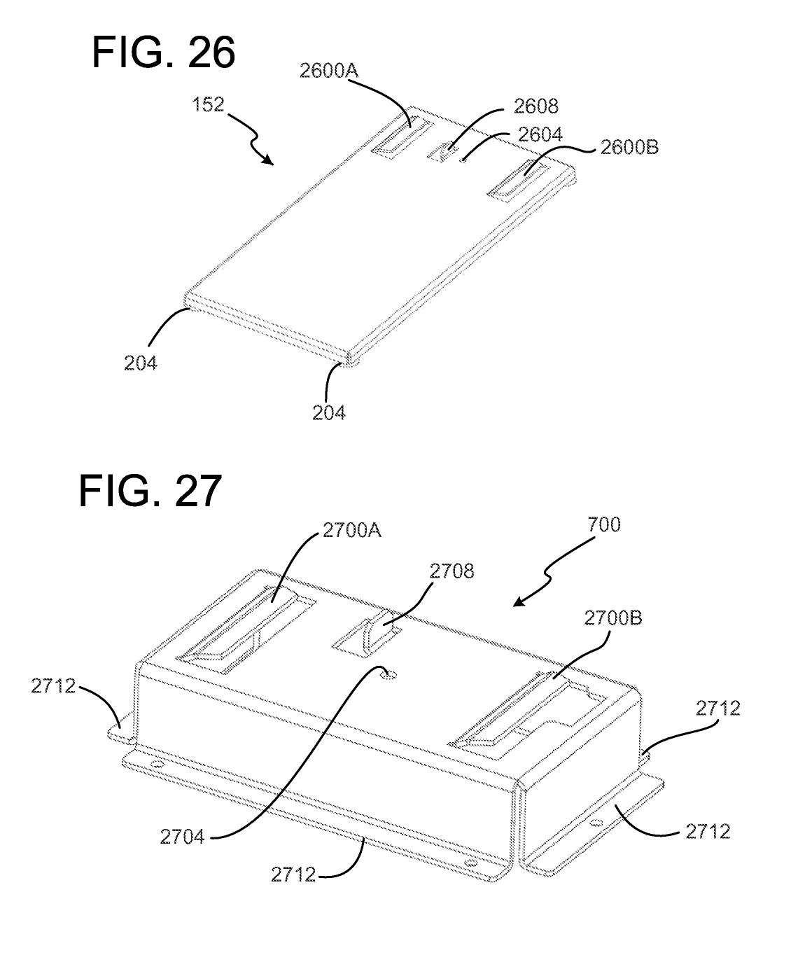

In the embodiment shown, movable horizontal mount 152 is made of sheet metal and includes a pair of outstanding receivers 2600A and 2600B formed from the sheet metal as shown particularly in FIG. 26. Each receiver 2600A and 2600B slidingly receives a corresponding engagement member (not shown) on each of the two legs 136A and 136B of chassis 136 of cutting apparatus 100. Chassis 136 includes a cross member 136C that extends between legs 136A and 136B and supports a screw arrangement 136D. A user uses screw arrangement 136D to secure cutting apparatus 100 to movable horizontal mount 152 by threadingly engaging the screw arrangement with a corresponding threaded opening 2604 (FIG. 26) on the movable horizontal mount once the engagement members on the legs are fully engaged with the corresponding respective L-shaped receivers on the movable horizontal mount. Many other ways exist for securing cutting apparatus 100 to movable horizontal mount 152. In this embodiment, movable horizontal mount 152 includes rubber feet 204, here suction cups, to enhance stability of cutting apparatus 100 during cutting operations. Other stability-enhancing features can be used. It is also noted that in the embodiment shown in FIG. 26, movable horizontal mount 152 also includes an alignment stop 2608 that assists a user in aligning cutting apparatus 100 so that screw arrangement 136D is properly aligned with threaded opening 2604 without requiring the user to fiddle with the alignment. Correspondingly, cross member 136C of chassis 136 of cutting apparatus 100 includes a corresponding stop (not shown) that contacts alignment stop 2608 when screw arrangement 136D is properly aligned with threaded opening 2604. In this embodiment, alignment stop 2608 and corresponding stop on chassis 136 are provided for convenience of the user and in lieu of relying on receivers 2600A and 2600B for alignment. In alternative embodiments, other alignment features can be provided.

FIGS. 7 and 8 illustrate that cutting apparatus 100 can be mounted to a fixed horizontal mount, such as universal fixed mount 700 oriented in a horizontal manner (see also FIG. 27), that can be secured to any suitable structure (not shown), such as a table, counter, or other work station. In this example, vertically mounted universal fixed mount 700 is made of sheet metal and includes lateral flanges 2712 for receiving mechanical fasteners (not shown) for securing the universal fixed mount to the support structure at issue. Horizontally mounted universal fixed mount 700 can be configured to receive cutting apparatus 100 in the same manner as movable horizontal mount 152 of FIGS. 1-6, so that the same attachment scheme can be used. For example and as seen in FIG. 7, screw arrangement 136D can be used to secure cutting apparatus 100 to universal fixed mount 700 after engaging engagement members (not shown) on base legs 136A and 136B (FIG. 1) with corresponding respective outstanding receivers 2700A and 2700B (FIG. 27) on the universal fixed mount. As those skilled in the art will readily appreciate, there are a variety of ways that cutting apparatus 100 can be secured to fixed horizontal mount 152 and that the fixed horizontal mount can be secured to a structure. Like movable horizontal mount 152 of FIG. 26 and as seen in FIG. 27, universal fixed mount 700 shown also includes a threaded opening 2704 and an alignment stop 2708 having the same functions as described above relative to threaded opening 2604 and alignment stop 2608 of movable horizontal mount 152 described above.

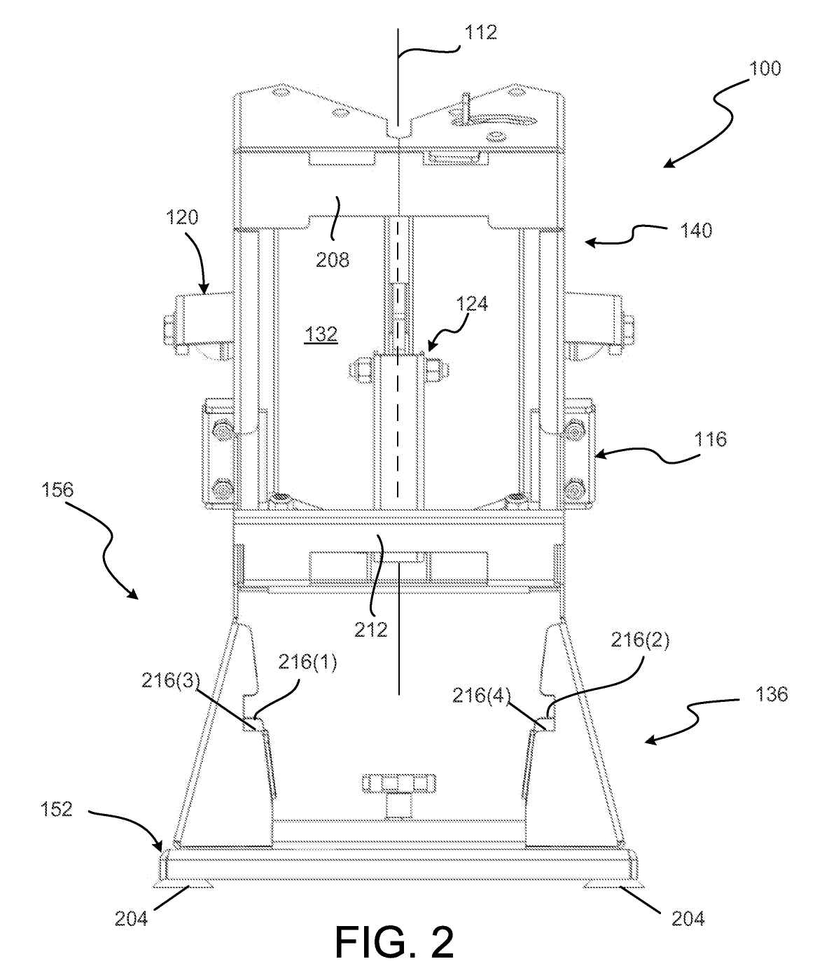

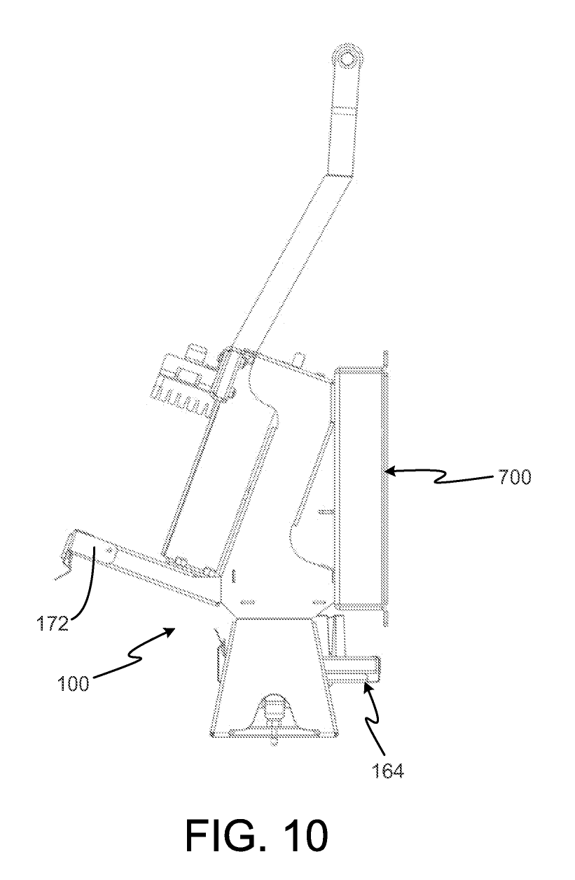

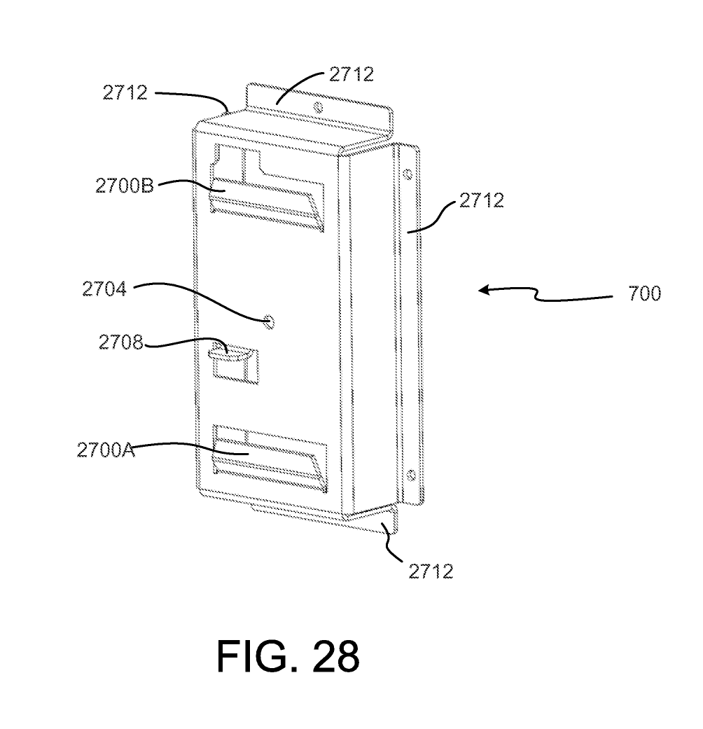

FIGS. 9 and 10 illustrate that cutting apparatus 100 can be engaged with a fixed vertical mount, such as universal fixed mount 700 oriented in a vertical manner (see also FIG. 28), that can be secured to any suitable structure (not shown), such as a wall or column, among other things. Again, and as seen in FIGS. 27 and 28, universal fixed mount 700 includes receivers 2700B and 2700A, which in the vertical orientation of the universal fixed mount open upwardly to receive corresponding respective upper and lower members 208 and 212 (FIGS. 2 and 8) so as to securely hold cutting apparatus 100 to the mount. As should be evident to those skilled in the art, since the same universal fixed mount 700 is used for both of the horizontal and vertical mounting scenarios illustrated herein, the spacing of upper and lower members 208 and 212 is virtually the same as the spacing of the members (not shown) on the bottoms of base legs 136A and 136B in order to make fixed mount 700 universal to both by way of receivers 2700A and 2700B. In other embodiments, different spacings can be used with either differing mounts or the same mount with different sets of receiver features.

### 2) Retractable Food Product Stabilizer

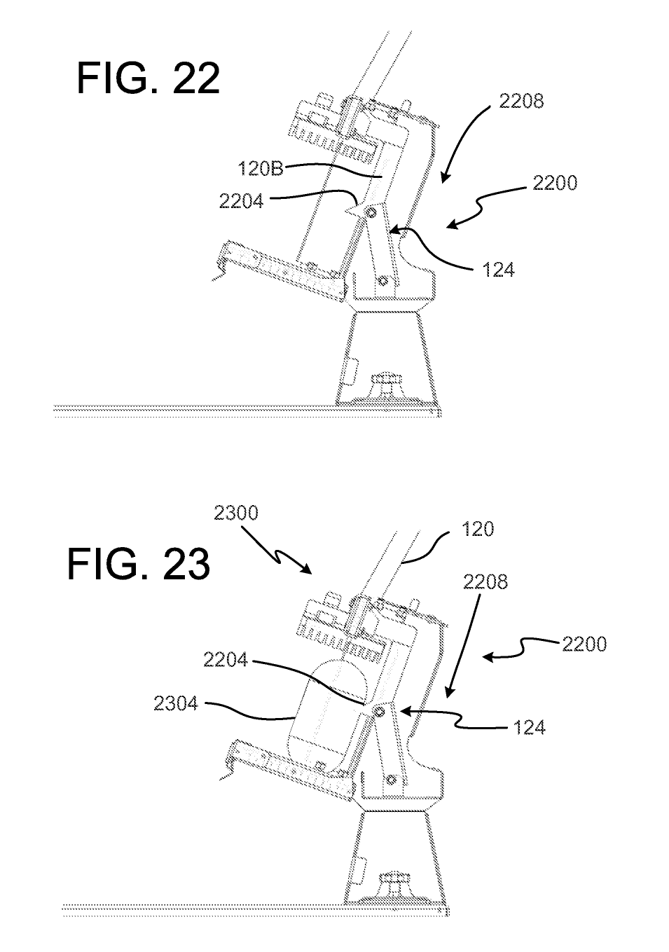

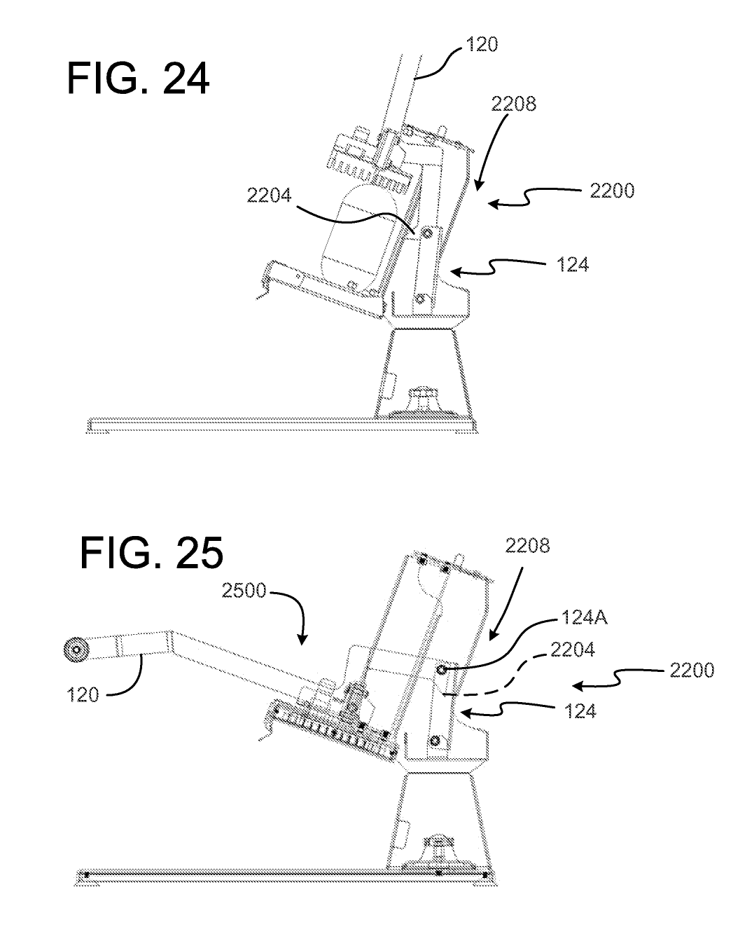

Referring now to FIGS. 22-25, these figures illustrate a cutting apparatus 2200 that is identical to cutting apparatus of FIGS. 1-21, except that cutting apparatus 2200 of FIGS. 22-25 includes the enhancement of including a retractable food product stabilizer 2204 added to linkage mechanism 124. As seen in the sequence of FIGS. 23-25 showing differing positions of pusher arm 120, as a user (not shown) moves the pusher arm from resting-open position 2300 (FIG. 23) to fully closed position 2500 (FIG. 25) during a cutting operation, pivot point 124A linkage mechanism 124 moves away from a food product 2304 (FIGS. 23 and 24) toward the rear 2208 of cutting apparatus 2200. In the example shown, food product stabilizer 2200 is a piercing member coupled to extension 120B of pusher arm 120 so as to be movable therewith. It is noted that while a single piercing member is shown, other embodiments may include more than one piercing member or one or more other types of stabilizers, such as a rest shaped to conformally receive the food product at issue or a gripper that grips the food product. It is also noted that the retractable food product stabilizer provided may be attached to another part of linkage mechanism 124 or other mechanism that operates in conjunction with the cutting operation. Retraction of food product stabilizer 2200, here the piercing member, during the cutting operation keeps the food product stabilizer from interfering with the cutting operation, but allows for keeping food product 2304 in the optimal position and orientation prior to the user beginning the cutting operation.

### 3) Cantilevered Blade Set

In cutting apparatus 100, blade set 104 is cantilevered from chassis 136 as seen in many of the figures, such as FIGS. 3-7, 9, and 10. This cantilevered arrangement solves a problem that many conventional vertically oriented thrust-type cutting apparatuses have, i.e., little or no room to place a catch container of any reasonable standard size. In many conventional cutting apparatuses of this type, their chasses are configured so that it is most practical to simply allow the cut food product to fall onto the supporting countertop at which point the user must transfer the cut food product into a container, such as by pulling it along the countertop to the edge and then into the container. Sometimes a small catch container can be positioned underneath the blade set, but often after having to fiddle with the orientation of the container and/or awkwardly maneuvering it through openings in the chassis. In contrast, with the cantilevered arrangement of blade set 104 of cutting apparatus 100, a user has 180° of unobstructed access to the space beneath the blade set and, thus, is free to place most any size catch container, or portion thereof, in that space.

### 4) Backward-Leaning Design

In addition to blade set 104 being cantilevered from chassis 136 as just described, overall, cutting apparatus 100 has a backward-leaning design in which cutting thrust axis 112 angles toward rear 312 (FIG. 3) at an angle, θ, as it extends from chassis 136. In this connection, it is noted that the cutting plane 320 of blade set 104 is perpendicular to cutting thrust axis 112, such that the cutting plane tilts upward by the same angle θ as it extends away from chassis 136. In the illustrated embodiment, angle θ is 20°, but in other embodiments it can be any other angle between 0° an 90°, and more typically in a range of about 10° to about 45°. This backward-leaning configuration provides a number of benefits. For example and as those skilled in the art can readily envision, with cutting plane 320 tilting upward, cut pieces (not shown) of the food product are ejected from blade set 104 in a direction somewhat away from chassis 136. This can be beneficial in allowing use of larger catch containers and to require less spreading out of the cut pieces as they accumulate in the catch container. Another benefit of the backward-leaning configuration is better ergonomics for the cutting operation relative to the actuation of pusher arm 120. With the backward-leaning orientation and proper design of pusher arm 120 and linkage mechanism 124, the movements needed from a user to operate the pusher arm are easy to make.

Yet another benefit of the backward-leaning configuration of cutting apparatus 100 is the interplay between the backward lean of cutting thrust axis 112 and upward tilt of cutting plane 320 on the one hand and product guide 132 on the other. In the embodiment shown, product guide 132 leans backward at the same angle θ as cutting thrust axis 112. To use cutting apparatus 100, when pusher arm 120 is in its resting-open position (FIG. 3), a user places a food product, such as a sliced or unsliced potato, onion, etc., onto blade set 104 and preferably in contact with both lateral sides 132A and 132B (see, e.g., FIG. 1) of product guide 132. With the backward lean, and the food product contacting each of lateral sides 132A and 132B and blade set 104, there are at least three points of contact between cutting apparatus 100 and the food product to provide the food product with stability. The backward lean of product guide 132 makes it easier for the user to find an orientation of the food product that is stable. Exemplary cutting apparatus 100 can be modified to include a retractable food product stabilizer, such as retractable food product stabilizer 2204 of FIGS. 22-25, which for many types of food product may be unnecessary because of their inherently stable shapes, such as spherical, that are suited to high stability with three-point support.

### 5) Blade-Cartridge/Pusher Set Storage

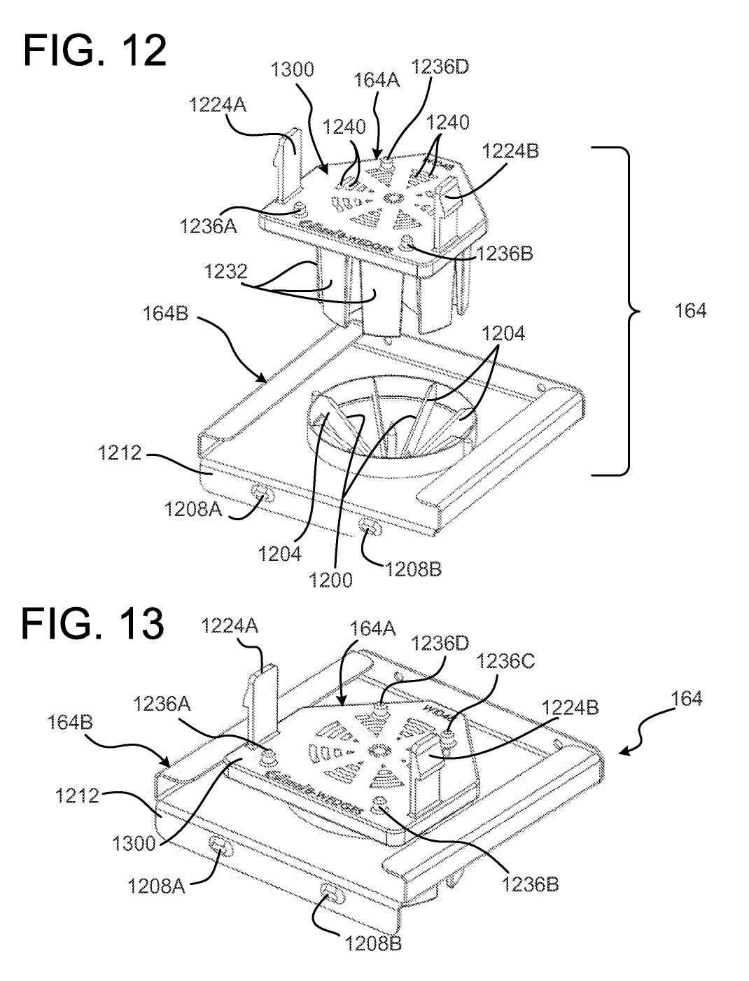

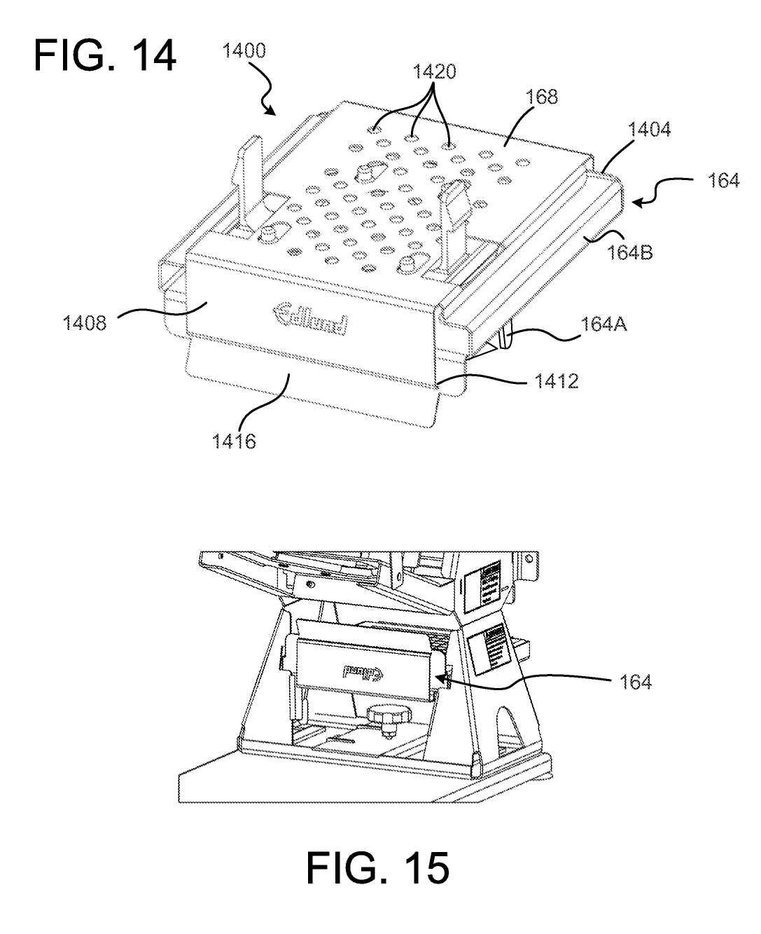

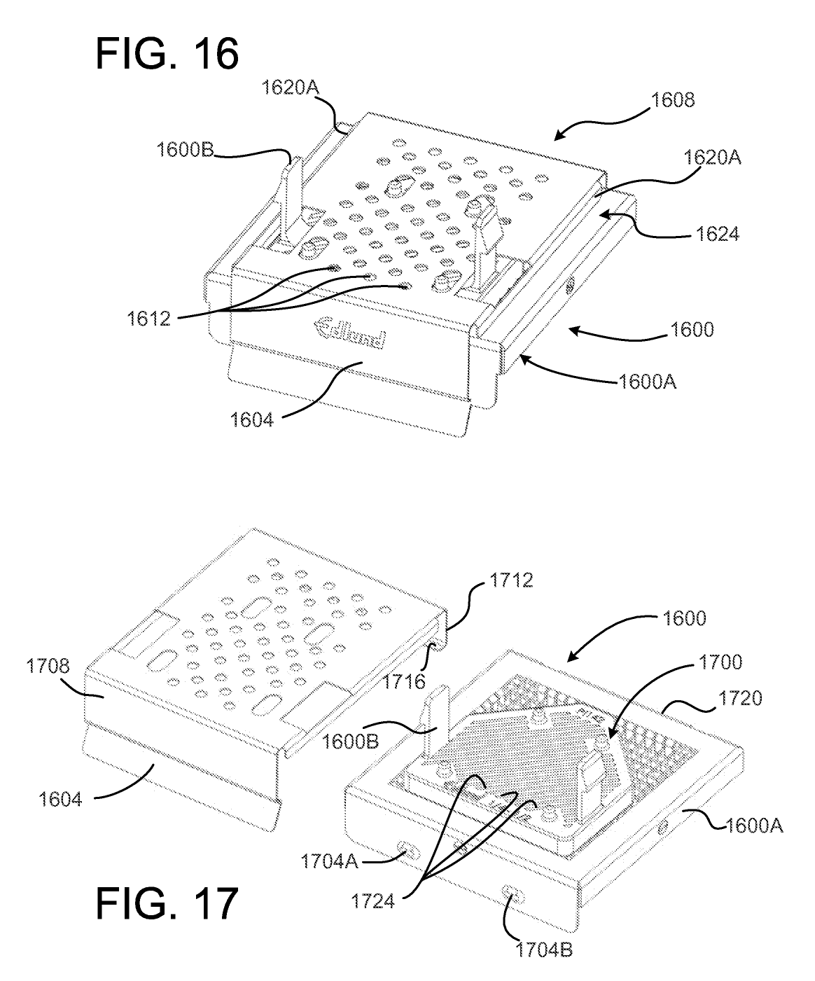

As seen in FIGS. 1, 2, 8-10, and 15, chassis 136 of cutting apparatus 100 is configured to receive a blade-cartridge/pusher set 164 (FIGS. 1, 9, 10, and 15) for storage. As described below in more detail, cutting apparatus 100 is designed to be readily reconfigurable in terms of pushers and matching blade sets. For example, by switching from a gridded pusher and blade set, for dicing and Julienning, to a wedging pusher and blade set, cutting apparatus 100 can be changed from a dicer/Julienner to a wedger. In this example, the blade-cartridge/pusher set storage capability can be handy for storing the blade-cartridge set not currently being used. In the embodiment shown, this storage capability is enabled by providing base legs 136A and 136B with suitable located receptacles 216(1) to 216(4) (FIG. 2) that slidingly receive blade-cartridge/pusher set 164. As best seen in FIGS. 1 and 10, in this example blade-cartridge/pusher set 164 includes a wedging pusher 164A (FIG. 1) and corresponding wedging blade cartridge 164B. FIGS. 12 and 13 illustrates wedging pusher 164A and blade cartridge 164B in greater detail and in an inverted orientation relative to FIGS. 1 and 10. In addition, FIG. 14 shows wedging pusher 164A and blade cartridge 164B engaged by a retainer 168 that holds the pusher in firm engagement with the blade cartridge, as described below in more detail. Wedging blade-cartridge/pusher set 164 can be swapped out for another type of set, such as the Julienning/dicing set 1600 shown in FIGS. 16 and 17. As seen in FIGS. 16 and 17, Julienning/dicing blade-cartridge/pusher set 1600 includes a gridded blade cartridge 1600A and a corresponding pusher 1600B, which in the example, are held together by a suitable retainer 1604. Other types of storage arrangements can be used.

6) Pusher/Blade-Cartridge Storage Retainer with Optional Wash Features

Referring again to FIGS. 12-14, as noted above FIG. 14 illustrates wedging blade-cartridge/pusher set 164 in which pusher 164A is held firmly in engagement with blade cartridge 164B by retainer 168, which functions to create a unitary assembly 1400 that is safe for handling and convenient for storage, such as in the manner described above in section 5. To create assembly, a user (not shown) engages pusher 164A, which as described below is readily removable from pusher assembly 116 (FIG. 1) of cutting apparatus 100, with corresponding blade-cartridge 164B as shown in FIG. 13 from the side of the blade cartridge having the sharp edges 1200 (FIG. 12) of the blades 1204. In this manner, when pusher 164A is fully inserted into blade cartridge 164B as shown in FIG. 13, the backing 1300 (FIG. 13) of the pusher covers sharp blade edges 1200 (FIG. 12), thereby blocking a user from contacting the sharp edges and preventing injury. Once the user has fully engaged pusher 164A with blade cartridge 164B, the user can install retainer 168 as shown in FIG. 14 to hold the pusher and blade cartridge together for convenient handling, storage, etc. As seen in FIG. 14, in the embodiment shown, retainer 168 is designed and configured to hook around the backside 1404 of blade cartridge 164B and provide a snap-fit engagement with a pair of spaced bosses 1208A and 1208B (FIG. 12) formed on the “front” 1212 of the blade cartridge. As those skilled in the art will understand, the “front” portion 1408 (FIG. 14) of retainer 168 is designed and configured to include a catch 1412 that catches on bosses 1208A and 1208B (FIG. 12) as the front portion springs back after leading end 1416 slides over the bosses during engagement of retainer 168 with blade-cartridge/pusher set 164. Other types of securing means, such as one or more slots and corresponding tab-type catches, a sliding-engagement arrangement, and/or one or more mechanical fasteners, among others, can be used to secure retainer 168 to blade-cartridge/pusher set 164.

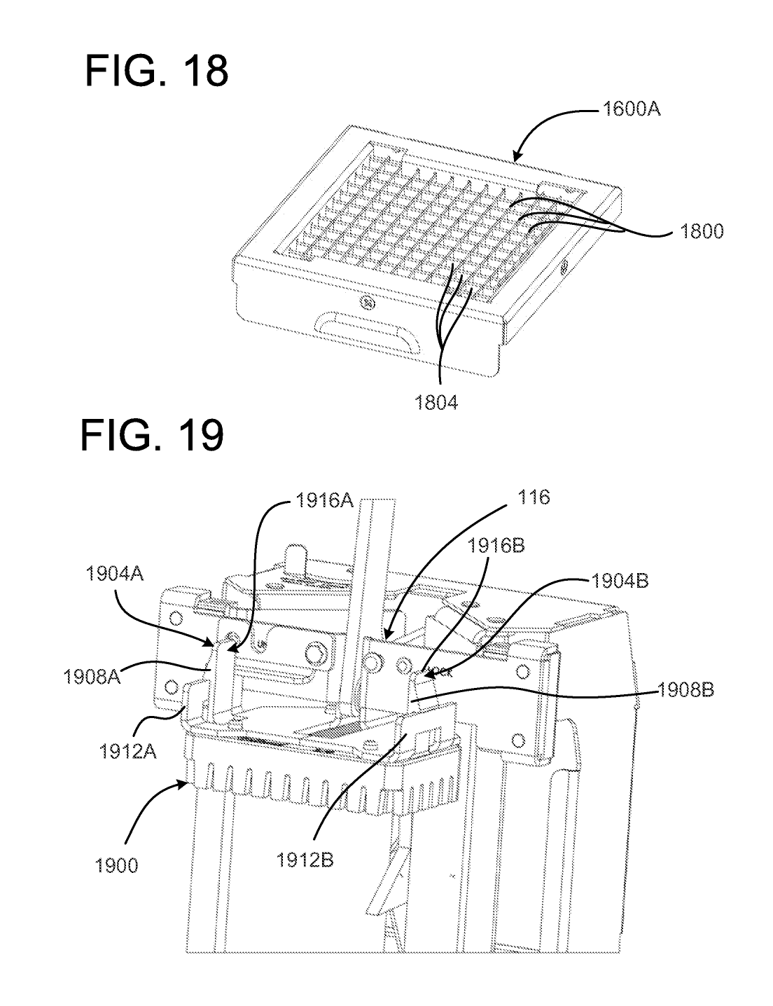

As noted above, FIG. 16 illustrate a similar assembly 1608 in the context of a Julienning/dicing blade-cartridge/pusher set 1600 in which retainer 1604 securely holds pusher 1600B in engagement with blade cartridge 1600A such that the backing 1700 (FIG. 17) of the pusher covers the sharp edges 1800 (FIG. 18) of the blades 1804 to protect a user from injury. Bosses 1704A and 1704B are the same in purpose and function as bosses 1208A and 1208B of FIG. 12 as shown on blade cartridge 1600A in FIGS. 17 and 18. Likewise, “front” portion 1708 (FIG. 17) is designed and configured to springingly snap-fit with and catch on bosses 1704A and 1704B in the manner described above in section 5 relative to retainer 168. FIG. 17 also illustrates how the “back” portion 1712 is configured with a flange 1716 to hook around the backside 1720 of blade cartridge 1600A. It is noted that retainer 1604 may be identical to retainer 168 so that only one universal configuration is needed. This simplifies manufacturing, stocking, etc.

Each of retainers 168 and 1604 described in this section can be provided with a liberal amount and/or extent of openings, such as corresponding respective openings 1420 (FIG. 14) and openings 1612 (FIG. 16) to allow wash-water and or wash-solution to freely circulate through corresponding respective assemblies 1400 and 1608.

### 7) Blade-Cartridge Lock

As seen in numerous figures, such as FIGS. 1, 3-7, 9, 10, and 21, cutting apparatus 100 includes a blade-cartridge lock 172 that is pivotably secured to blade-cartridge receiver 148. In all but FIG. 21, blade-cartridge lock 172 is shown in its locked position such that it retains blade cartridge 144 securely in blade-cartridge receiver 148 during cutting operation. In FIG. 21, however, blade-cartridge lock 172 is shown in its unlocked position 2100, pivoted upward and backward to reveal front 2104 of blade cartridge 144. When blade-cartridge lock 172 is in unlocked position 2100, a user can remove and reinstall blade cartridge 144 or install another blade cartridge, such as either blade cartridge 164B or 1600A described above. In addition, when blade-cartridge lock 172 is in unlocked position 2100, the blade-cartridge lock partially blocks a user from placing food product onto blade cartridge 144 and blocks a user from moving pusher 108 through blade set 104 to complete a cutting operation. Rather, the user must move blade-cartridge lock 172 into its closed position (FIGS. 1, 3-7, 9, and 10) before a cutting operation. This ensures that blade cartridge 144 is secure during any cutting operation.

As seen in FIG. 21, blade cartridge 144 includes a boss 2108 on its front 2104. This boss is identical in function to bosses 1208A and 1208B of FIG. 12 and bosses 1704A and 1704B of FIG. 17. In addition to boss 2108 providing the same function as bosses 1208A and 1208B and bosses 1704A and 1704B described above, it also provides a similar snap-fit catching function for blade-cartridge lock 172. As seen in FIG. 21, blade-cartridge lock 172 is designed and configured to include a catch 2112 that catches on boss 2108 when the blade-cartridge lock is pivoted from the open position 2100 of FIG. 21 to the closed position illustrated in FIGS. 1, 3-7, 9, and 10. This provides cutting apparatus 100 with a convenient tool-less and fastener-less arrangement for securing locking blade cartridge 144 into place.

### 8) Quick-Connect Pusher

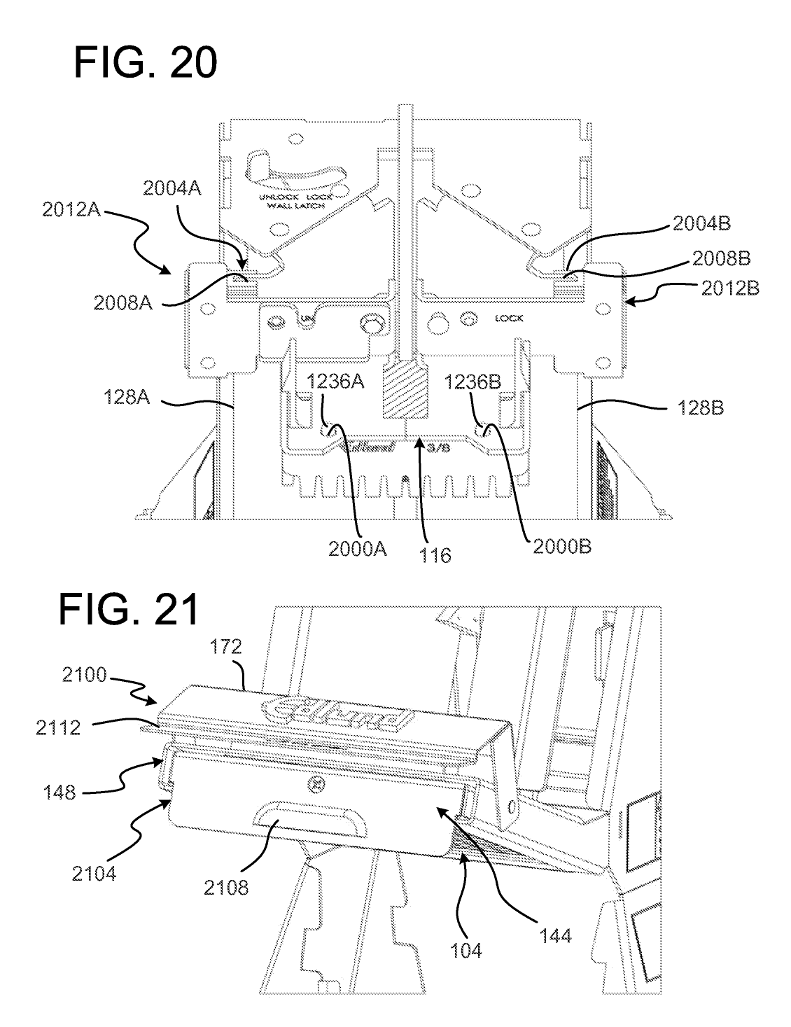

As seen in many of the accompanying figures, but especially in FIG. 19, each pusher, here, pusher 1900 used with cutting apparatus 100 is provided with a pair of locking members 1904A and 1904B that include corresponding respective catches 1908A and 1908B that springingly catch on corresponding respective pusher supports 1912A and 1912B of pusher assembly 116. In the configuration shown in FIG. 19, to remove pusher 1900 from pusher assembly 116, a user pinches toward one another upper ends 1916A and 1916B of locking members 1904A and 1904B to move catches 1908A and 1908B out of engagement with pusher supports 1912A and 1912B and then lower the pusher relative to the pusher assembly. As those skilled in the art can readily envision, to install pusher 1900 after being removed, a user moves the pusher into position below pusher assembly 116 and aligns locking members 1904A and 1904B with pusher supports 1912A and 1912B, respectively, and then pushes upward on the pusher so that the locking members elastically bend slightly toward one another until catches 1908A and 1908B snap-fittingly engage the pusher supports. In the embodiment shown in FIG. 19, locking members 1904A and 1904B are metal tabs overmolded into pusher 1900. In other embodiments, such as pusher 164A of FIGS. 12 and 13, locking members 1224A and 1224B are made of plastic and are molded integrally with backing 1300 of the pusher, as are fingers 1232 of the pusher. As also seen in FIGS. 12 and 13, backing 1300 also includes alignment features 1236A to 1236D that help to ensure the alignment of pusher 164A with corresponding blade cartridge 164B during cutting operations. Alignment features engage corresponding respective openings on pusher assembly 116, such as seen in FIG. 20 with two of the alignment features 1236A and 1236B shown engaging openings 2000A and 2000B, respectively.

### 9) Anti-Binding Pusher-Assembly Guide Mechanism

As described above, cutting apparatus 100 includes a pair of slide rails 128A and 128B, which in this embodiment are integrated monolithically with V-shaped product guide 132. Referring to FIG. 20, slide rails 128A and 128B are slidingly engaged, respectively, by a pair of slides 2004A and 2004B, which are secured to pusher assembly 116 and are made of polytetrafluoroethylene (PTFE) to provide excellent sliding ability. Each slide 2004A and 2004B in this example is an elongated block of PTFE having a central channel 2008A and 2008B that snugly receives a corresponding one of slide rails 128A and 128B. The flat configuration of slide rails 128A and 128B, the “self-lubricating” design of slides 2004A and 2004B, and the tight fit of channels 2008A and 2008B with the slide rails make the corresponding guide mechanisms 2012A and 2012B resistant to binding. As those skilled in the art will appreciate, conventional designs having circular rods as guides are prone to binding, especially when the interaction of the pusher with a food product causes eccentric forces on the pusher relative to the slide axes of the guide rods. This binding problem is solved using guide mechanisms the same as or similar to guide mechanisms 2012A and 2012B.

10) Monolithic Pusher having Wash-Enhancing Features

FIGS. 12, 13 and 17 illustrate two monolithic pushers 164A and 1600B made of a suitable material, such as plastic, among others. In both of pushers 164A and 1600B, their backings 1300 and 1700, respectively, are integrally formed with their fingers 1232 in the case of pusher 164A, but the fingers are not seen in FIG. 17 for pusher 1600B, though similar fingers 900 are seen in FIG. 9. As seen in FIG. 12, backing 1300 of pusher 164A includes a plurality of arcuate slotted openings 1240 that allow wash-water and/or wash-solution to pass through the backing and into the spaces formed among fingers 1232 to enhance washability of the pusher. Similarly, as seen in FIG. 17, backing 1700 of pusher 1600B includes diagonal slotted openings 1724 that intersect with the grid-like pattern of channels formed by the rectangular fingers on the opposite side of backing 1700. The diagonal arrangement of openings 1724 provide pusher 1600B with structural stability, since the diagonal-slotted openings are arranged so that for slots crossing near the diagonal center of an underlying finger, that finger is supported by the remaining portions of backing 1700 on either side of that slot. This provides pusher 1600B with a very rigid structure. The unique six-sided shape of each pusher 164A and 1600B is a result of making the pusher shape conform to the V-shape of product guide 132. As described above, FIGS. 29-32 illustrate an easy-clean Julienning/dicing pusher similar to pusher 1600B, and FIGS. 32 to 34 illustrate an exemplary alternative easy-clean configuration of the backing.

11) Blade Cartridge having Simplified Blade-Tensioning Arrangement

Referring now to FIG. 11, this figure illustrates an exemplary construction 1100 of a Julienning/dicing blade cartridge. In this example, construction 1100 includes a blade grid 1104 comprising crisscrossing perpendicular blades 1108 (one direction) and 1112 (the other direction) in which all of the blades have the same depth as one another. This crisscross pattern of blade grid 1104 provides a plurality of food openings 1114 through which the food product (not shown) passes as the corresponding pusher, such as food pusher 108 of FIG. 1, pushes the food product into and through the blade grid. Where crisscrossing occurs, each of the corresponding respective blades 1108 and 1112 is notched to half of its depth to receive the un-notched portion of the other blade. In this manner, each of blades 1108 and 1112 is continuous across the length/width of blade grid 1104 and the cutting edges 1108A and 1112A of the blades all lie in a common plane. Construction 1100 also includes a two-part frame 1116 that comprises an inner part 1116A and an outer part 1116B, each having a pair of slotted grid retainers 1120A and 1120B and 1124A and 1124B, respectively on two adjacent sides. Each slotted grid retainer 1120A, 1120B, 1124A, and 1124B has a plurality of slots 1128 for receive a corresponding one of blades 1108 or 1112 so that the corresponding grid retainer can be located inboard of the first blade 1108(1), 1108(2), 1112(1), and 1112(2) along the corresponding respective ends of blade grid 1104. As a skilled artisan can readily envision, when blade grid 1104 is placed between inner and outer frame parts 1116A and 1116B with slotted grid retainers 1120A, 1120B, 1124A, and 1124B properly engaged with the corresponding respective end blades 1112(1), 1108(1), 1112(2), and 1108(2) by pivoting the outer frame part as shown by arrow 1132, the two frame parts can be biased against one another in the plane of the grid, such as with screws, in a manner that tensions blades 1108 and 1112 in both directions of blade grid 1104. Such a two-part frame 1116 and grid construction greatly simplifies creating a Julienning/dicing blade cartridge.

### 12) Pusher-Arm Mechanism

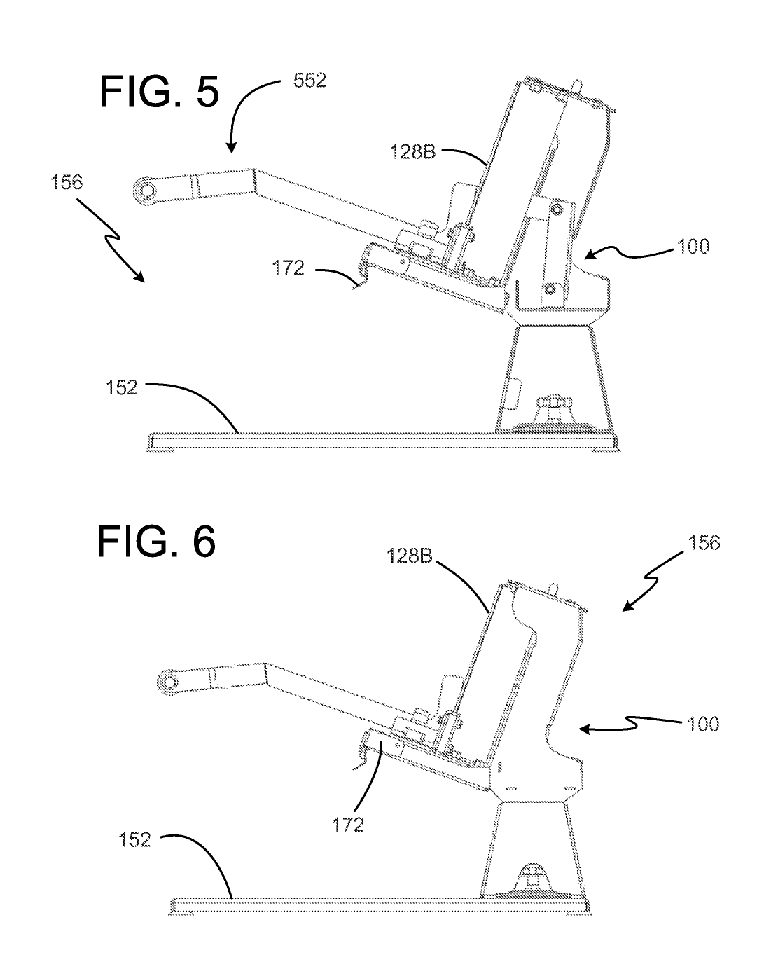

Returning to FIGS. 3-5, these figures illustrate a series of positions of pusher arm 120 prior to and during a cutting operation, ranging from a resting-open position 352 of FIG. 3, to an intermediate position 452 in FIG. 4, and a fully closed position 552 in FIG. 5. Pusher arm 120 and linkage mechanism 124 are integrally designed to provide cutting apparatus 100 with a compact design as well as beneficial features, such as self-stabilized resting-open position 352 of FIG. 3 and the ability to readily integrate a retractable food product stabilizer, such as stabilizer 2204 described above in section 2 relative to FIGS. 22-25. As those skilled in the art can readily appreciate, the geometry of linkage mechanism 124 in combination with the geometry of pusher arm 120, including the offset extension 120B cooperate to allow the overall size of cutting apparatus 100 to be smaller in a front-to-back dimension and overall height with the pusher arm in a fully open position relative to a cutting device having a similar general configuration but lacking the two-link linkage mechanism and the special geometries of this mechanism and the pusher arm.

Referring to FIG. 3, the configuration of pusher arm 120 and linkage mechanism 124 make resting-open position 352 stable, such that one or more springs or other biasing means are not needed to keep pusher assembly 116 in spaced relation from blade set 104 to keep cutting apparatus 100 ready for receiving a food product for a slicing operation. Link 124B has a U-shaped cross-section with the U-shape generally opening toward front 300 of cutting apparatus, and the end of lever-arm extension 120B at pivot point 124A is located between the two legs of the U-shape. As those skilled in the art will readily understand, when pusher arm 120 is in the leaning-back position shown in FIG. 3, lever-arm extension 120B rests on link 124B on the base of the U-shape at the end of link 124B proximate to pivot point 124A. In essence, the base of the U-shape of link 124B provides a travel stop for lever-arm extension 120B. When the center of gravity of pusher arm 120 is positioned behind the plane 356 of side supports 128, the pusher arm tends to pivot in a clockwise direction (relative to FIG. 3) where it is attached to pusher assembly 116, thereby keeping lever-arm extension 120B in contact with the base of the U-shape of link 124B, thereby making resting-open position 352 stable. Those skilled in the art will appreciate that other configurations of lever-arm extension 120B and/or link 124B can be used to provide a suitable travel stop that provides pusher arm 120 with a stable resting-open position.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A food product pusher for a food product cutting apparatus having a pusher holder and a blade set having a Julienning/dicing blade grid defining a plurality of food openings through which the food product pusher pushes food during a cutting operation of the food product cutting apparatus, the food product pusher comprising:
a plurality of pusher fingers defined by first set of channels having first longitudinal axes extending in a first direction and a second set of channels having a second longitudinal axes extending in a second direction different from said first direction so that said first set of channels cross said second set of channels so as to define said pusher fingers and to form a plurality of intersections, said first and second sets of channels being located so that, when the food product pusher is engaged with the pusher hold, the pusher hold can push the food product pusher so that said pusher fingers extend, correspondingly and respectively, into the food openings of the Julienning/dicing blade grid; and
a backing supporting said pusher fingers in fixed relation to one another and having a back side opposite said pusher fingers, said backing including a plurality of wash openings extending from said back side to said first and second sets of channels, wherein each of said wash openings fluidly communicates with at least one of said intersections.

2. A food product pusher according to claim 1, wherein said pusher fingers are arranged in a regular rectangular grid pattern and said wash openings comprise a plurality of diagonal slots that each fluidly communicate with multiple ones of said intersections.

3. A food product pusher according to claim 2, wherein each pair of diagonally adjacent ones of said pusher fingers have a root spacing and each of said diagonal slots has a width equal to or greater than said root spacing.

4. A food product pusher according to claim 3, wherein said width is greater than said root spacing.

5. A food product pusher according to claim 2, wherein said backing comprises a perimeter frame and a plurality of parallel diagonal support stringers supporting said pusher fingers and defining said diagonal slots.

6. A food product pusher according to claim 1, wherein said pusher fingers are arranged in a rectangular grid pattern and each of said intersections having a root area, said wash openings including one wash opening for each of said intersections, wherein each said one wash opening having a transversion cross-sectional area greater than said root area so as to expose portions of said channels of said first and second sets of channels forming said intersection corresponding to that one of said wash openings so that portions of adjoining ones of said pusher fingers are visible through said that one of said wash openings.

7. A food product pusher according to claim 6, wherein each of said wash openings is cylindrical in shape.

8. A food product pusher according to claim 1, wherein each wash opening is configured to fluidly communicate with at least one of said intersections and is configured to expose portions of said channels of said first and second sets of channels forming said at least one intersection so that portions of adjoining ones of said pusher fingers are visible through said that one of said wash openings.

9. A food product pusher according to claim 8, wherein said wash openings comprise diagonal slots that each fluidly communicate with multiple ones of said intersections.

10. A food product pusher according to claim 8, wherein said wash openings comprise a plurality of apertures each corresponding to a respective one of said intersections.

11. A food product pusher according to claim 1, wherein said back side has a shape that can be broken into only a first primary shape and a second primary shape by drawing an imaginary line between the first and second primary shapes, wherein said first primary shape is a rectangle and said second primary shape is either a trapezoid or a triangle.
